(19) United States
(12) Patent Application Publication
(10) Pub. No.: US 2014/0068982 A1
(43) Pub. Date: Mar. 13, 2014

(54) Specialized Dosage Label with Shutter Window and Easy Open Strip

(71) Applicant: Thomas J. Silvano, Little Falls, NJ (US)

(72) Inventor: Thomas J. Silvano, Little Falls, NJ (US)

(21) Appl. No.: 14/044,351

(22) Filed: Oct. 2, 2013

Related U.S. Application Data
(63) Continuation-in-part of application No. 13/861,163, filed on Apr. 11, 2013.
(60) Provisional application No. 61/644,001, filed on May 8, 2012.
(60) Provisional application No. 61/709,553, filed on Oct. 4, 2012.

(51) Int. Cl. G09F 3/00; G09F 3/10

(52) U.S. Cl. CPC G09F 3/0288; G09F 3/10
USPC 40/638; 156/250; 156/247

(57) ABSTRACT

A system and method for labeling containers requiring information to be printed thereon using an improved dosage label having a shutter window. The dosage label has a first edge, a base layer extending from the first edge, and a top layer positioned above the base layer and extending from the first edge. The base layer includes a rear surface having substantially permanent pressure sensitive adhesive coating for adhering to the outside surface of the container and a front surface having a release coating. The top layer has a rear surface having substantially permanent pressure sensitive adhesive coating and a front surface. The top layer is applied on top of the base layer from the first edge to a first position covering the base layer and includes a break defining a tab. The shutter window of the top layer is peeled back by the tab from the base layer.

### CROSS-REFERENCE TO RELATED APPLICATION

This application is a continuation in part of pending U.S. application Ser. No. 13/861,163 for Nested Wrap Label filed on Apr. 11, 2013 and claiming the benefit of provisional patent application Ser. No. 61/644,001 filed in the United States Patent and Trademark Office on May 8, 2012. This application further claims the benefit of provisional patent application Ser. No. 61/709,553 filed in the United States Patent and Trademark Office on Oct. 4, 2012. All of the identified and cross-referenced applications are hereby incorporated by reference in their entirety.

### BACKGROUND OF THE INVENTION

1. Field of the Invention

This invention relates generally to labeling systems, and more particularly to a system and method for labeling containers requiring large amounts of information to be printed thereon using an improved dosage label having a convenient and easy to peel back shutter window.

2. Description of the Related Art

Small containers of the type used for pharmaceutical products are labeled with ingredients, instructions, side effects, warnings and the like, in a variety of different ways. Commonly, adhesive labels are utilized which affix to the containers directly and contain a large amount of necessary written information.

Labeling is done essentially to establish brand identity and provide information to consumers on what a product is, how it should be used, when the product should be used and appropriate dosage.

How that information is accessed and made available to the consumer is the essence of the design of the invention. The purpose of the invention is to provide an efficient way to enable consumers to access dosage information as well as other pertinent information relating to how, when, and how much should be used of a product as well as any other information necessary for the correct use of the product. It does not require custom bottles or specialized labeling equipment and production line efficiency is not negatively affected in any way.

While the prior art units may be suitable for the particular purpose employed, or for general use, they would not be as suitable for the purposes of the present invention as disclosed hereafter.

It is, therefore, a primary object of the present invention to provide an improved dosage label providing convenient access to information printed thereon.

It is another object of the present invention to provide an improved dosage label having an easy to use peel back shutter window for partially peeling back the top layer of the label and containing additional printed information thereunder.

It is another object of the present invention to provide an improved dosage label having a principle display panel containing important information thereon that remains unaffected by interference, potential damage or wrinkling created by the peel back shutter window.

It is another object of the present invention to provide an improved dosage label capable of being applied to any size, shape or type of existing container or bottle.

It is another object of the present invention to provide an improved dosage label capable of being produced without negatively effecting production line efficiency during production output on label manufacturing lines.

It is another object of the present invention to protect the top layer of the improved dosage label from damage by having an overprint UV gloss varnish covering important information thereon.

It is another object of the present invention to provide an aesthetically pleasing improved dosage label wherein the top layer is one smooth sleek single plane created for coupling to an outside of a container.

### BRIEF SUMMARY OF THE INVENTION

In accordance with one aspect of the present invention a label is provided having a first edge for securing to an outside surface of a container. The label includes a base layer having a first, second and third area and front and rear surface. The first area of the front surface has a release coating and printed information thereon, wherein the second and third areas of the front surface are free of the coating. The label includes a top layer having a first, second and third area and a front and rear surface. Both surfaces having printed information thereon and the printed top layer includes a substantially elongated break between the first and third areas. The first area of the rear surface of the printed top layer has a release coating. The second area of the rear surface of the printed top layer has substantially permanent pressure sensitive adhesive coating. The first and second areas of the rear surface of the printed top layer is positioned adjacent the first and second areas of the front surface of the printed base layer extending from the first edge to the break to enable the first area of the printed top layer to selectively releasably adhere by the tab to the first area of the front surface of the printed base layer.

The label includes a tab along the first area of the printed top layer adjacent the break.

The second area of the rear surface of the printed top layer of the label is permanently adhered to the second area of the front surface of the printed base layer.

The third area of the rear surface of the printed top layer of the label is permanently adhered to the third area of the front surface of the printed base layer.

The rear surface of the base layer of the label includes a substantially permanent pressure sensitive adhesive coating for adhering to the outside surface of the container.

The first, second and third areas of the front surface of the printed top layer of the label include an ultra violet gloss varnish.

The first area of the printed top layer of the label is a shutter window.

The second area of the front surface of the printed top layer of the label is a principle display panel.

In accordance with an additional embodiment a method of creating a label is provided having a top layer having a shutter window, and a base layer for securing to an outside surface of a container, wherein the layers include information for a consumer thereof. The steps include printing information on a front surface of the base layer. Next, the method includes applying a release coating to a first area of the printed front surface of the base layer. Next, the method includes printing information on both a front and a rear surface of the top layer. Next, the method includes applying a substantially permanent pressure sensitive adhesive coating to the rear surface of the printed top layer. Next, the method includes stacking together the rear surface of the printed top layer with the front surface of the printed base layer. Next, the method includes die cutting the label to create a break and a tab in the printed top layer enabling the shutter window to releasably adhere to the first area of the front surface of the printed base layer.

The base layer includes a rear surface having a substantially permanent pressure sensitive adhesive coating and the method further includes the step of adhering the rear surface of the base layer to the outside surface of the container.

The method includes the step of creating a repeating pattern of base layers on a continuous spool of releasable backing material.

The method includes the step of die cutting the label to size and shape.

In accordance with an additional embodiment, a method for displaying information on a container having an outside surface is provided. The steps include providing a label having a first edge, a base layer extending from the first edge, and a top layer positioned above the base layer and having a break therein. The top layer has a tab adjacent the break. The base layer includes a rear surface having a substantially permanent pressure sensitive adhesive coating and a front surface having a release coating. The top layer has a rear surface having a substantially permanent pressure sensitive adhesive coating and a front surface.

The next step includes securing the top layer from the first edge to a first position substantially covering the base layer, wherein the substantially permanent pressure sensitive adhesive rear surface of the top layer interacts with the release coating on the front surface of the base layer to selectively hold the top layer in the first position. The next step includes peeling back the shutter window from the base layer by the tab at the break of the top layer.

The method includes printing information on both sides of the top layer and on the front surface of the base layer.

The method includes adhering the rear surface of the base layer to the outside surface of the container.

The method includes applying an ultra violet gloss varnish to the front surface of the top layer.

The method includes opening and closing a portion of the top layer as a shutter window.

The method includes displaying a portion of the front surface of the printed top layer as a principle display panel.

### BRIEF DESCRIPTION OF THE SEVERAL VIEWS OF THE DRAWINGS

To these and to such other objects that may hereinafter appear, the present invention relates to a system and method for labeling containers requiring information to be printed thereon using an improved dosage label as described in detail in the following specification and recited in the annexed claims, taken together with the accompanying drawings, in which like numerals refer to like parts in which:

FIG. 1 is a perspective view of an improved dosage label affixed to an outside surface of a cylindrical container in accordance with the present invention;

FIG. 2 is a perspective view of the dosage label in a first position in accordance with the present invention including information about a medicine;

FIG. 3 is a perspective view of the dosage label in a second position in accordance with the present invention including information about a medicine;

FIG. 4 is a perspective view of a spool of material containing a plurality of dosage labels in accordance with the application of the present invention;

FIG. 5A is a top plan view of the dosage label having a top layer and base layer in accordance with the application of the present invention;

FIG. 5B is a top plan view of a rear surface of the top layer of the dosage label of FIG. 5A in accordance with the present invention; and

FIG. 5C is a top plan view of a front surface of the base layer of the dosage label of FIG. 5A in accordance with the present invention.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

The present invention is directed to a system and method for labeling containers requiring large amounts of information to be printed thereon using an improved dosage label that is reduced in length. Preferably, the present invention is used on small plastic containers of the type used for pharmaceutical products.

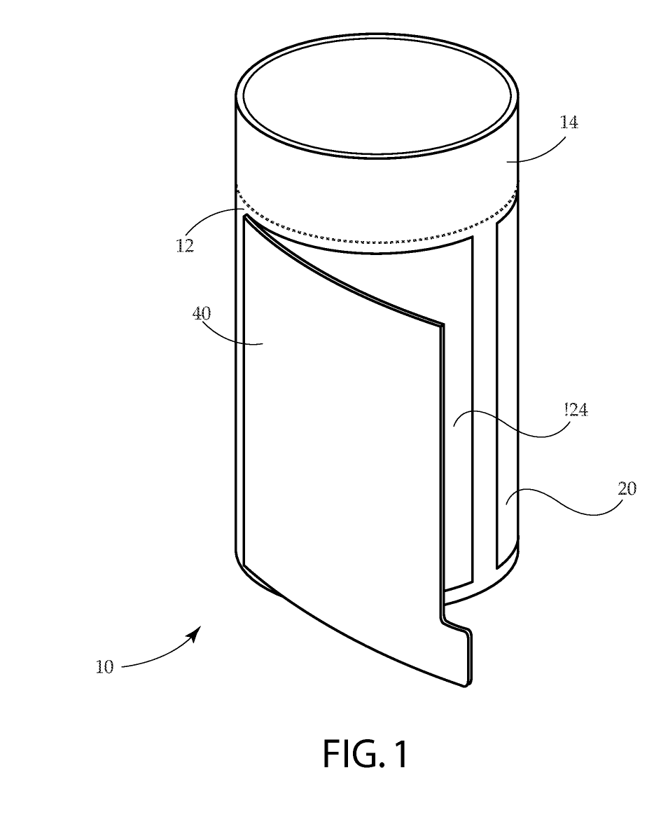

FIG. 1 illustrates a container 10, and specifically a cylindrical bottle for holding pharmaceutical items therein. The container 10 commonly holds medication in the form of pills or tablets of the type found in drug stores and supermarkets. The container 10 has an outside surface 12 and includes a twist off lid 14.

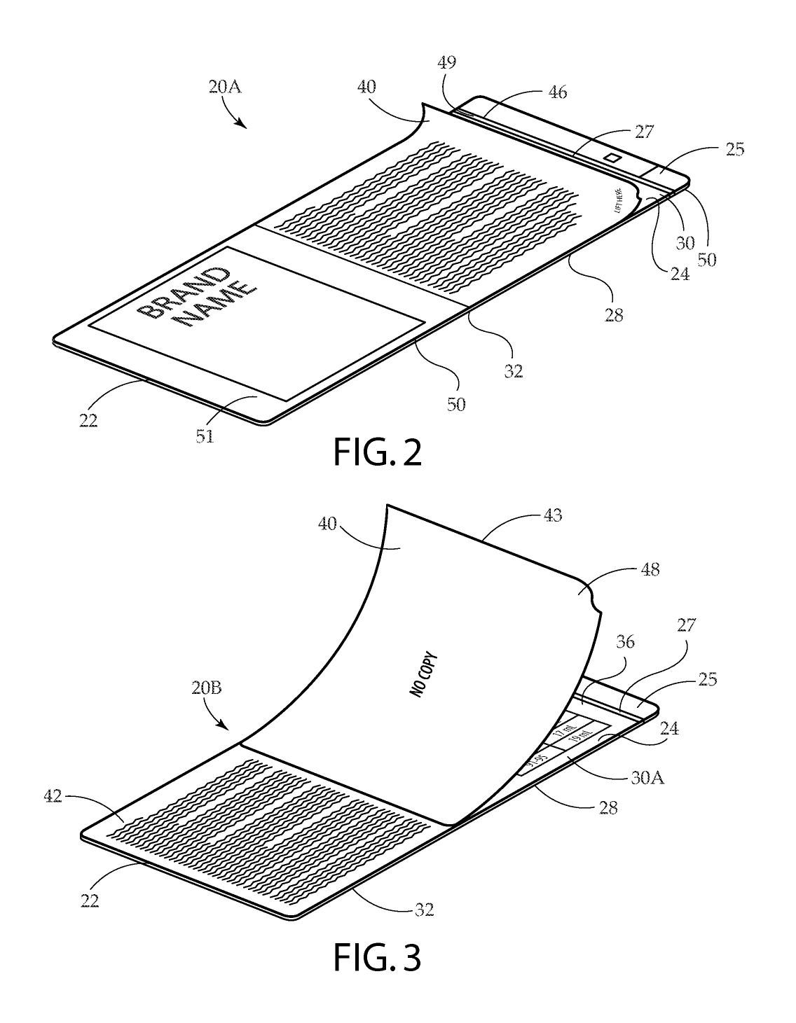

FIG. 2 illustrates a dosage label 20 for wrapping around, and adhering to, the outside surface 12 of the container. In alternate embodiments, the dosage label 20 may also wrap around and adhere to portions of the lid 14. Specifically, when there are concerns with tampering or spoiling of goods within the container, the safety lids 12 may be used. In these circumstances, the dosage label 20 may include a safety seal to cover a portion of the lid 12 to eliminate tampering with or destroying the contents.

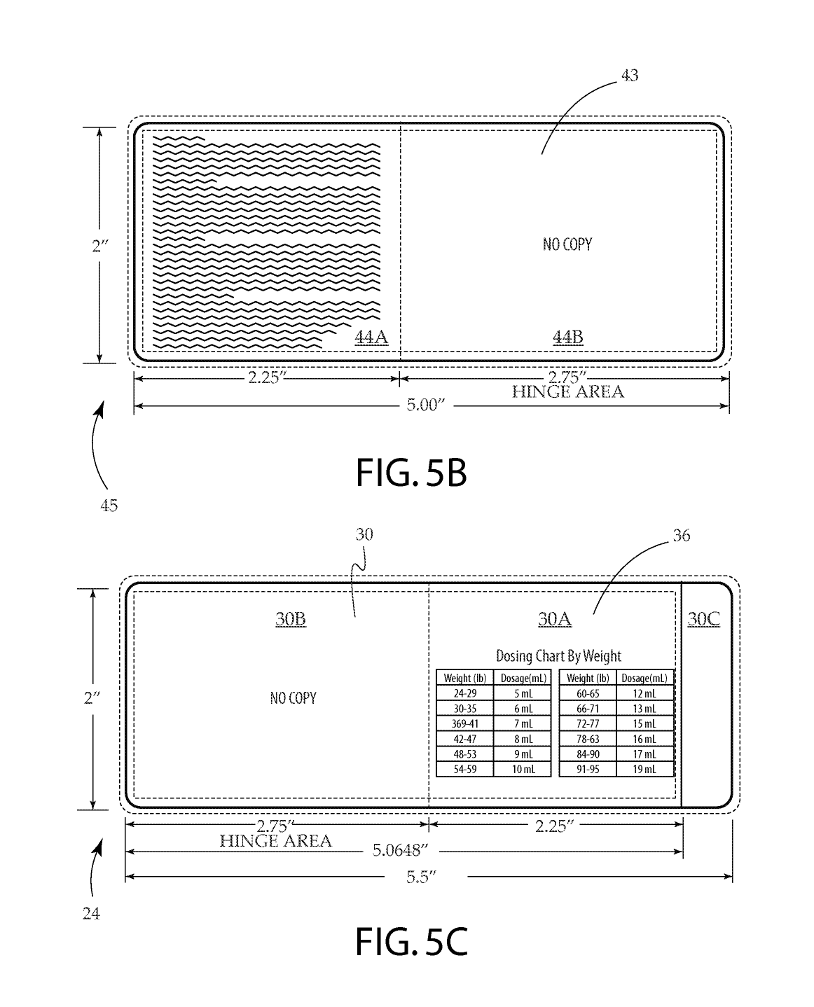

The dosage label 20, illustrated in FIGS. 5A-5C, includes a first edge 22. The first edge 22 is defined along a common plane by the coupling of a base layer 24 underneath a top layer 40. The base layer 24 includes a first area 30A, a second area 30B and a third area 30C. The base layer 24 extends from the first edge 22 at the second area 30B to the first and then third areas 30A, 30C. The base layer 24 has a rear surface 28 and a front surface 30. The rear surface 28 contains a substantially permanent pressure sensitive adhesive coating 32 for adhering the label 20 to the container 10. The first area 30A of the front surface 30 includes a release coating 36, while the second and third areas 30B, 30C of the front surface 30 are free of the coating for allowing more permanent adherence to the top layer 40. The second area 30B is also known as the principle display panel and contains important brand messaging or other content information valuable to consumers that is not wrinkled, damaged or otherwise affected during peel back of the top layer 40. Generally, the front surface 30 contains printed dosage information thereon relative to the contents of the container 10. Most commonly, the printed information on the base and top layers 24, 40 pertains to ingredients, warnings, side effects, instructions for use and storage of medications within the container 10.

As illustrated in FIG. 5A, the top layer 40 is positioned above the base layer 24. The top layer includes a break 46 and extends from the first edge 22 above the base layer 24 to the break 46 and continues after the break, such that the base layer 24 is sandwiched between the container 10 and the top layer 40 while in a first position 20A. The top layer 40 has a front surface 42 and a rear surface 43 and includes a first area 44A, a second area 44B, and a third area 44C. During the method, the top layer 40 is initially one continuous layer positioned on top of the base layer 24. The top layer 40 is die cut during the method to create two preferably separate portions defined by a break 46 or improved opening means. While die cutting is the preferred method for creating the break 46 in the top layer, other methods are contemplated and incorporated herein for creating such break 46. Specifically, a first portion 45 is created, which includes the first and second areas 44A, 44B and a second portion 47 is created, which includes the third area 44C. The die cut creates the opening means by removing a thin strip of material from the top layer 40 creating the break 46 between the first and third areas 44A, 44C in order to create separate and distinct first and second portions 45, 47 respectively. After the thin strip of material of the top layer 40 is removed, a strip 49 of material from the first area 30A of the base layer 24 is exposed through the break 46. In addition, the die cut also creates a peeling means or tab 48 within the first portion 44A of the top layer 40 adjacent the break 46. Together the opening means and peeling means, break 46 and tab 48 respectively, allow the first area 44A of the top layer 40 to function as a shutter window by easily, conveniently and selectively peeling back from the base layer 24.

Preferably, the front surface 42 of the top layer 40 contains a protective overprint UV gloss varnish or coating 51 for protecting the label from normal wear during dispensing of medication, and transportation and storage of the container 10. Preferably, the front surface 42 of the top layer 40 at the third area 30C includes a portion free of varnish having lot and expiration information printed thereon for contents of the container 10.

Both the front and rear surfaces 42, 43 of the top layer 40 contain printed information thereon relative to the contents of the container 10. Preferably, the front surface 42 contains brand information and warnings. The rear surface 44 of the top layer 40 contains a substantially permanent pressure sensitive adhesive coating 50, which in the first position shown in FIGS. 2 and 5A, allows the first area 44A of the top layer 40 to adhere to the release coating 36 on the first area 30A of the front surface of the base layer 24. The second and third areas 44B, 44C of the top layer 40 permanently adhere to the second and third areas 30B, 30C of the base layer 24.

FIG. 3 illustrates the dosage label 20 in a second position 20B wherein the release coating 36 on the base layer 24 allows the first area 44A of the top layer 40 to function as a shutter window and peel back from the base layer 24 by the tab 48 at the break 46 to a second position uncovering at least a portion of the base layer 24. Preferably, approximately one-half of the base layer 24 including all of the first area 33A is capable of being uncovered. While in the second position a user may read printed warning information contained on the rear surface 43 of the top layer 40, which may be continued from the front surface 42 of the top layer 40, and important dosage information on the first area 30A of the front surface 30 of the base layer 24.

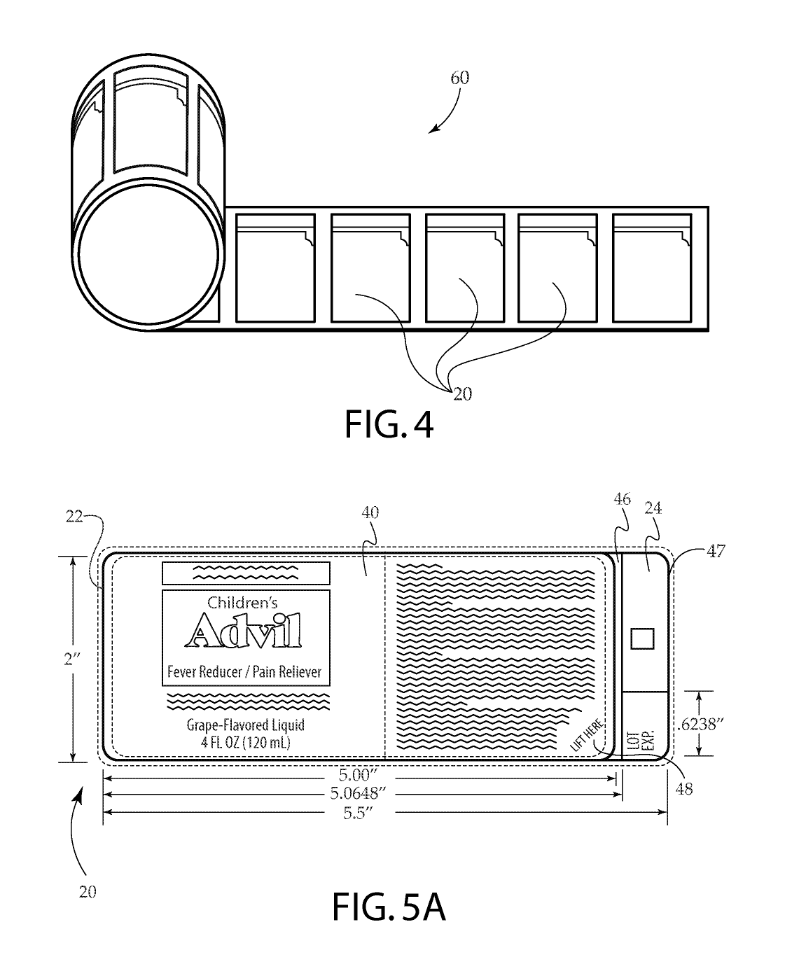

FIG. 4 illustrates a spool or web of material 60 containing a line of dosage labels 20 thereon. Preferably, a line of base layers 24 and top layers 40 are each produced on separate webs of material before being combined to form the dosage label 20. In particular, the base layer 24 is produced in a repeating pattern along a first web of material by first printing information on the front surface 30 of the base layer 24. Then, a release coating 36 is applied to the first area 30A of the printed front surface 30 of the base layer 24. The base layer 24 is then die cut and the excess material is removed, leaving the base layer 24 on a continuous web. Die cutting may also create a perforated safety seal, which may be part of the base layer 24 and affixes over or around the lid 14. The seal is easily ripped off from the base layer 24 at the perforation, when a user twists open or pops-up the lid of the container 10 for the first time, thus providing that the contents of the container have not been tampered with after packaging. Next, the top layer 40 is produced in repeating pattern along a second web of material by printing information on both the front and rear surfaces 42, 43 of the top layer 40. Then, a substantially permanent pressure sensitive adhesive coating 50 is applied to the rear surface 43 of the printed top layer 40 to adhere the top layer 40 to the base layer 24. Finally, the rear surface 43 of the printed top layer 40 is stacked on top of the front surface 30 of the printed base layer 24 to form the dosage label 20. The label 20 is then die cut again for removing the thin strip of material from the top layer 40 between the first and third areas 44A, 44C in order to create separate and distinct first and second portions 45, 47 respectively. The top layer 40 is able to releasably adhere to the first area 30A of the front surface of the base layer 24, while being more permanently affixed to the second area 30A of the base layer 24 defining the first edge 22. The second and third areas 30B, 30C of the base layer 24 are free of the release coating 36, thus allowing the substantially permanent pressure sensitive adhesive coating 50 thereon to non-removably adhere to the base layer 24.

As shown in FIG. 1, the dosage label 20 is affixed around the outside surface 12 of the container 10. When the dosage label 20 is affixed to the container 10 the base layer 24 is applied directly to the outside surface 12 of the container, while the top layer 40 is positioned thereon and simultaneously wrapped around the container 10. In the preferred embodiment, shown in FIGS. 5A-5C, the top layer 40 is of equal in length to the base layer 24 for providing a sleek, smooth single plane label. In alternate embodiments, the top layer 40 may be shorter or longer in length from the base layer. Thus once the base layer 24 is affixed to the container the top layer 40 is simultaneously fully applied.

A user interested in reading the printed information contained on the base and top layers 24, 40 begins by reading the front surface 42 of the top layer 40 which easily and clearly provides brand and warning information. Then, the user peels back the top layer 40 from the base layer 24 by the tab 48 along the break 46, and may continue reading the printed warning information contained on the rear surface 43 of the first area 44A of the top layer 40. As the first area 44A of the top layer 40 or shutter window is unwrapped from the base layer 24, the affixed second area 44B or principle display panel of the top layer 40 remains untouched. Thus, the user may peel back the shutter window and continue to view important brand information on the principle display panel while continuing to read information on the first area 30A of the base layer 24 underneath the shutter window.

In conclusion, herein is presented system and method for labeling containers requiring dosage information to be printed thereon using an improved dosage label that is easy to use and locate important information contained thereon. The invention is illustrated by example in the drawing figures, and throughout the written description. It should be understood that numerous variations are possible, while adhering to the inventive concept. Such variations are contemplated as being a part of the present invention. While one preferred embodiments of the present invention has been disclosed for purposes of illustration, it is obvious that many modifications and variations could be made thereto. It is intended to cover all of those modifications and variations, which fall within the scope of the present invention as defined by the following claims.

We claim:

1. A label having a first edge for securing to an outside surface of a container, comprising:
a base layer having a first, second and third area and front and rear surface, wherein the first area of the front surface having a release coating and printed information thereon, wherein the second and third areas of the front surface free of said coating; and
a top layer having a first, second and third area and a front and rear surface, both surfaces having printed information thereon, wherein the printed top layer includes a substantially elongated break between said first and third areas, wherein said first area of said rear surface of said printed top layer having a release coating, wherein said second area of said rear surface of said printed top layer having substantially permanent pressure sensitive adhesive coating, wherein said first and second areas of said rear surface of said printed top layer is positioned adjacent said first and second areas of said front surface of said printed base layer extending from said first edge to said break to enable said first area of said printed top layer to selectively releasably adhere by said tab to said first area of said front surface of said printed base layer.

2. The label of claim 1 further comprising a tab along the first area of the printed top layer adjacent the break.

3. The label of claim 1 wherein the second area of the rear surface of the printed top layer is permanently adhered to the second area of the front surface of the printed base layer.

4. The label of claim 1 wherein the third area of the rear surface of the printed top layer is permanently adhered to the third area of the front surface of the printed base layer.

5. The label of claim 1 wherein the rear surface of the base layer includes a substantially permanent pressure sensitive adhesive coating for adhering to the outside surface of the container.

6. The label of claim 1 wherein the first, second and third areas of the front surface of the printed top layer include an ultra violet gloss varnish.

7. The label of claim 1 wherein the first area of the printed top layer is a shutter window.

8. The label of claim 1 wherein the second area of the front surface of the printed top layer is a principle display panel.

9. A method of creating a label having a top layer having a shutter window, and a base layer for securing to an outside surface of a container, wherein said layers include information for a consumer thereof, the steps comprising:
a. printing information on a front surface of the base layer;
b. applying a release coating to a first area of the printed front surface of the base layer;
c. printing information on both a front and a rear surface of the top layer;
d. applying a substantially permanent pressure sensitive adhesive coating to the rear surface of the printed top layer;
e. stacking together the rear surface of the printed top layer with the front surface of the printed base layer; and
f. die cutting the label to create a break and a tab in the printed top layer enabling the shutter window to releasably adhere to the first area of the front surface of the printed base layer.

10. The method of claim 9 wherein the base layer includes a rear surface having a substantially permanent pressure sensitive adhesive coating and further comprising the step of adhering the rear surface of the base layer to the outside surface of the container.

11. The method of claim 9 further comprising the step of creating a repeating pattern of base layers on a continuous spool of releasable backing material.

12. The method of claim 9 further comprising the step of die cutting the label to size and shape.

13. The method of claim 9 further comprising the step of applying further comprising applying ultra violet gloss varnish to the front surface of the top layer.

14. A method for displaying information on a container having an outside surface, the steps comprising:
a. providing a label having a first edge, a base layer extending from said first edge, and a top layer positioned above said base layer and having a break therein, wherein:
the top layer having a tab adjacent said break,
the base layer includes a rear surface having a substantially permanent pressure sensitive adhesive coating and a front surface having a release coating, and the top layer has a rear surface having a substantially permanent pressure sensitive adhesive coating and a front surface;
b. securing the top layer from the first edge to a first position substantially covering the base layer, wherein the substantially permanent pressure sensitive adhesive rear surface of the top layer interacts with the release coating on the front surface of the base layer to selectively hold the top layer in said first position; and
c. peeling back the shutter window from the base layer by the tab at the break of the top layer.

15. The method of claim 14 further comprising printing information on both sides of the top layer and on the front surface of the base layer.

16. The method of claim 14 further comprising adhering the rear surface of the base layer to the outside surface of the container.

17. The method of claim 14 further comprising applying ultra violet gloss varnish to the front surface of the top layer.

18. The method of claim 14 further comprising opening and closing a portion of the top layer as a shutter window.

19. The method of claim 14 further comprising displaying a portion of the front surface of the printed top layer is a principle display panel.
